(19) United States
(12) Patent Application Publication
(10) Pub. No.: US 2024/0113547 A1
(43) Pub. Date: Apr. 4, 2024

(54) Power Supply System

(71) Applicant: TOYOTA JIDOSHA KABUSHIKI KAISHA, Toyota-Shi Aichi-ken (JP)

(72) Inventor: Hirotsugu OHATA, Susono-shi Shizuoka-ken (JP)

(73) Assignee: TOYOTA JIDOSHA KABUSHIKI KAISHA, Toyota-Shi Aichi-ken (JP)

(21) Appl. No.: 18/369,881

(22) Filed: Sep. 19, 2023

(30) Foreign Application Priority Data
Sep. 30, 2022 (JP) 2022-158489

(51) Int. Cl. H02J 7/00; B60L 53/22

(52) U.S. Cl. CPC H02J 7/007182; B60L 53/22; H02J 7/0013; H02J 7/0047; H02J 7/0063; B60L 2210/30; B60L 2210/40; B60L 2240/547; H02J 2207/20

(57) ABSTRACT

A power supply system is composed of a plurality of cell units connected in parallel. Each of the cell units includes a battery pack and a converter. The control device carries out feedback control only under proportional control such that a unit output voltage which is an output voltage from the cell unit attains to a voltage command inputted from a PCS.

### CROSS REFERENCE TO RELATED APPLICATIONS

This nonprovisional application is based on Japanese Patent Application No. 2022-158489 filed with the Japan Patent Office on Sep. 30, 2022, the entire contents of which are hereby incorporated by reference.

### BACKGROUND

### Field

The present disclosure relates to a power supply system and particularly to a power supply system in which a plurality of cell units each including a cell and a converter are connected in parallel.

### Description of the Background Art

Japanese Patent Laying-Open No. 2014-103804 discloses a technique to equalize voltages of a plurality of battery assemblies in a cell system in which the plurality of battery assemblies are connected in parallel.

### SUMMARY

In a cell system (power supply system) in which a plurality of battery assemblies (cells) are connected in parallel, voltages of the cells are different due to a difference in characteristic of the cells or deterioration of the cells, and a circulating circuit is generated. A converter may be provided for each set of cells connected in parallel to suppress the circulating circuit to thereby suppress deterioration of the cells caused by the circulating circuit.

In a power supply system where cell units each including a cell and a converter are connected in parallel, an output voltage and output power of the power supply system are desirably controlled to desired values. For example, the converter in each cell unit is controlled based on a voltage command and a power command required by a load or the like connected to the power supply system. In this case, voltage control may be carried out in a prescribed cell unit such that the output voltage from the power supply system attains to a voltage command and power control may be carried out in another cell unit such that output power from the power supply system attains to a power command.

When a difference between output power and a power command in power control is produced (power deviation occurs) due to an error of various sensors or response delay or the like in control, the output voltage varies. Since voltage control is carried out in response to variation in output voltage due to power deviation, an amount of operations by the cell unit subjected to voltage control may increase, loads (power burdens) imposed on a prescribed cell unit (cell unit subjected to voltage control) may increase, and deterioration of the prescribed cell unit may be accelerated.

An object of the present disclosure is to equalize loads (burdens) imposed on cell units in a power supply system in which cell units each including a cell and a converter are connected in parallel.
(1) A power supply system in the present disclosure includes a plurality of cell units connected in parallel, each of the plurality of cell units including a cell and a converter, and a control device that controls the converter. The control device carries out voltage control to control the converter in each of the plurality of cell units with a voltage command being defined as an input parameter, the voltage command being a command value for an output voltage from the power supply system.

According to this configuration, each of the converters of the cell units connected in parallel is subjected to voltage control, with a voltage command RV being defined as the input parameter. Since voltage control is carried out in each cell unit even when power deviation occurs, loads (power burdens) imposed on the cell units can be equalized.
(2) In some embodiments, in (1), the power supply system further includes a voltage sensor that detects a unit output voltage VO (N) which is an output voltage from each of the plurality of cell units. The voltage control carried out by the control device may be feedback control only under proportional control such that unit output voltage VO (N) attains to voltage command RV.

When an integral term (integral control) is included in feedback control of each of the cell units connected in parallel such that unit output voltage VO (N) attains to voltage command RV, the integral term controls output power (an output current) from each cell unit to eliminate a steady difference, which may cause control interference between cell units. According to this configuration, since feedback control is carried out only under proportional control such that unit output voltage VO (N) attains to voltage command RV, control interference between cell units can be suppressed.
(3) In some embodiments, in (2), a gain in the proportional control is set such that variation in unit output voltage VO (N) is within a prescribed range.

Since the integral term (integral control) is not included in feedback control carried out only under proportional control such that unit output voltage VO (N) attains to the voltage command, unit output voltage VO (N) is less likely to converge to voltage command RV. When the gain in proportional control is increased such that unit output voltage VO (N) is brought closer to voltage command RV, unit output voltage VO (N) greatly varies. According to this configuration, the gain in proportional control is set such that variation in unit output voltage VO (N) is within the prescribed range, so that variation in unit output voltage VO (N) can be accommodated in an allowable range of the load or the like while unit output voltage VO (N) is brought closer to the voltage command.
(4) In some embodiments, in (1), the power supply system further includes a voltage sensor that detects unit output voltage VO (N) which is an output voltage from each of the plurality of cell units and an output power obtaining unit that obtains unit output power OP (N) which is output power from each of the plurality of cell units. The control device includes a power command calculator that calculates a unit power command TP (N) which is a command value for unit output power OP (N) based on a power command RP which is a command value for output power from the power supply system and a voltage command correction unit that calculates a corrected voltage command RV (N) by correcting voltage command RV to be smaller as a difference between unit power command TP (N) and unit output power OP (N) is larger while unit output power OP (N) is larger than unit power command TP (N) and correcting voltage command RV to be larger as the difference between unit power command TP (N) and unit output power OP (N) is larger while unit output power OP (N) is smaller than unit power command TP (N). The voltage control carried out by the control device may be feedback control such that unit output voltage VO (N) attains to corrected voltage command RV (N).

When voltage control is carried out in each cell unit in order to equalize loads (burdens) imposed on cell units, control interference between cell units may occur. According to this configuration, the voltage command correction unit calculates corrected voltage command RV (N) corrected to decrease voltage command RV as the difference between unit power command TP (N) and unit output power OP (N) is larger while unit output power OP (N) is higher than unit power command TP (N). The voltage command correction unit calculates corrected voltage command RV (N) corrected to increase voltage command RV as the difference between unit power command TP (N) and unit output power OP (N) is larger while unit output power OP (N) is lower than unit power command TP (N). Since feedback control is carried out such that unit output voltage VO (N) attains to corrected voltage command RV (N), unit output voltage VO (N) of the cell unit is controlled to be lower while unit output power OP (N) is higher than unit power command TP (N), and unit output voltage VO (N) of the cell unit is controlled to be higher while unit output power OP (N) is lower than unit power command TP (N), control interference between cell units can be suppressed.
(5) In some embodiments, in (4), the voltage command correction unit may set voltage command RV to corrected voltage command RV (N) when unit output power OP (N) is equal to unit power command TP (N).

According to this configuration, when unit output power OP (N) is equal to unit power command TP (N), voltage command RV is set to corrected voltage command RV (N), without voltage command RV being corrected. Therefore, the output voltage from the power supply system can be controlled to attain to voltage command RV.
(6) In some embodiments, in (5), the voltage command correction unit may calculate corrected voltage command RV (N) such that relation between the difference and corrected voltage command RV (N) is linear.

According to this configuration, since relation between the difference between unit power command TP (N) and unit output power OP (N) and corrected voltage command RV (N) is linear, unit output voltage VO (N) can be controlled in a stable manner.
(3) In some embodiments, in (1) to (6), a three-phase inverter may be diverted for use as the converter, and cells different from one another may be connected to arms of respective phases of the three-phase inverter.

An electrically powered vehicle such as a hybrid electric vehicle (HEV) or a battery electric vehicle (BEV) has more widely been used in recent years. Recycle or reuse of a battery (cell) or a power control unit (PCU) collected on the occasion of replacement purchase or disassembly of these vehicles is desired. According to this configuration, a three-phase inverter of the collected PCU can be diverted for use as a converter of the power supply system (cell unit), so that reuse of the PCU can be promoted. When a collected battery (cell) is also used as the cell of the power supply system (cell unit), reuse of the battery can also be promoted.

The foregoing and other objects, features, aspects and advantages of the present disclosure will become more apparent from the following detailed description of the exemplary embodiments when taken in conjunction with the accompanying drawings.

### BRIEF DESCRIPTION OF THE DRAWINGS

FIG. 1 is a diagram showing an overall configuration of a power supply system in the present embodiment.

FIG. 2 is a diagram illustrating an exemplary electrically powered vehicle.

FIG. 3 is a diagram showing an exemplary configuration of a control device of the power supply system.

FIG. 4 is an exemplary block diagram for control of output power from the power supply system in a first embodiment.

FIG. 5 is an exemplary block diagram for control of output power from the power supply system in a second embodiment.

FIG. 6 is a diagram illustrating a corrected voltage command calculated by a voltage command correction unit.

FIG. 7 is a diagram illustrating a control device of the power supply system according to a first modification.

FIG. 8 is a diagram showing an overall configuration of a power supply system in a second modification.

### DESCRIPTION OF THE EMBODIMENTS

An embodiment of the present disclosure will be described in detail below with reference to the drawings. The same or corresponding elements in the drawings have the same reference characters allotted and description thereof will not be repeated.

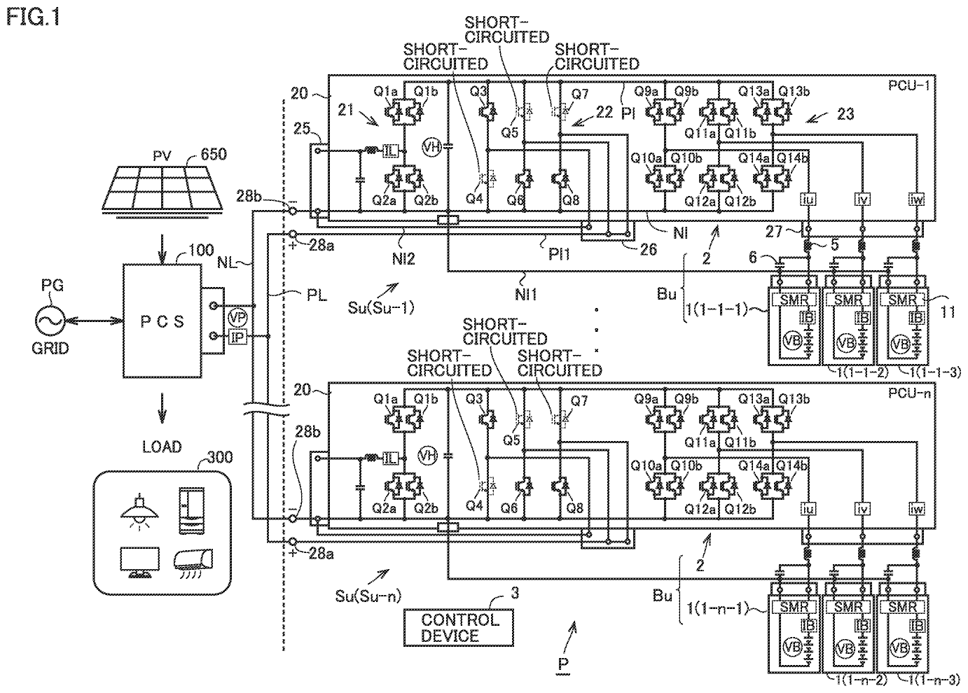

FIG. 1 is a diagram showing an overall configuration of a power supply system P in the present embodiment. Power supply system P includes a power supply sub unit Su and a control device 3, power supply sub unit Su including three battery packs 1 and a converter 2. In the present embodiment, a battery pack and a power control unit (PCU) mounted on an electrically powered vehicle are diverted for use as power supply sub unit Su in power supply system P. An exemplary configuration of an electrically powered vehicle on which a battery pack and a PCU are mounted will be described.

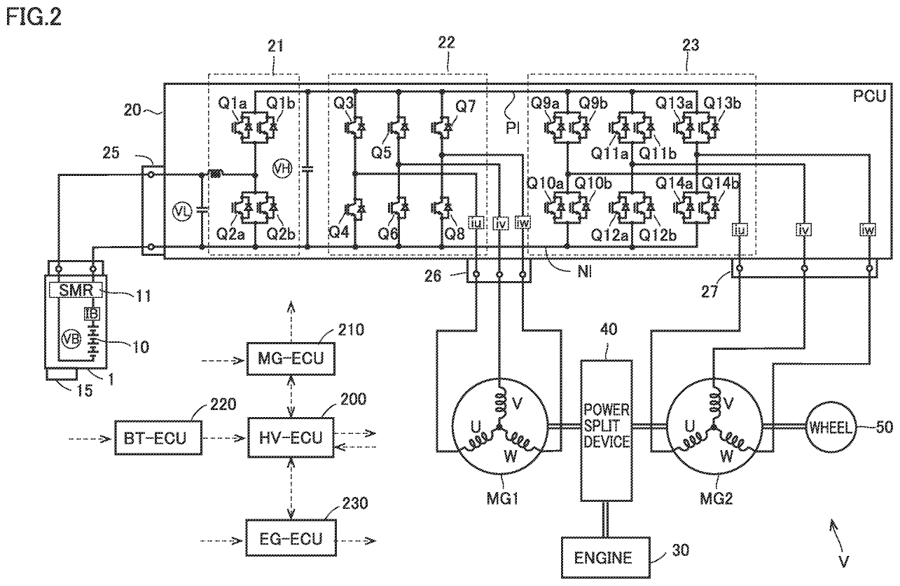

FIG. 2 is a diagram illustrating an exemplary electrically powered vehicle. In FIG. 2, an electrically powered vehicle V is a hybrid electric vehicle in which a rotating electric machine and an engine are both used for drive of the vehicle. Electrically powered vehicle V includes battery pack 1, a PCU 20, an engine 30, motor generators MG1 and MG2 as rotating electric machines, a power split device 40, and a drive wheel 50.

Battery pack 1 includes a battery 10 and a system main relay (SMR) 11. Battery 10 is a battery assembly in which cells each implemented by a secondary battery such as a nickel metal hydride battery or a lithium ion battery are electrically connected in series. Battery pack 1 has an output terminal (a positive terminal and a negative terminal) connected to a battery connection terminal 25 of PCU 20. As SMR 11 is closed, battery 10 and PCU 20 are connected to each other. As SMR 11 is opened, battery 10 and PCU 20 are disconnected from each other. Battery pack 1 is provided with a monitoring unit 15 that detects a voltage VB of battery 10, an input and output current IB to and from battery 10, a temperature TB of battery 10, and the like.

PCU 20 includes a boost converter 21, an inverter 22, and an inverter 23. Boost converter 21 boosts battery voltage VB inputted from battery pack 1 and outputs the boosted battery voltage to inverter 22 and inverter 23. Inverter 22 converts direct-current (DC) power boosted by boost converter 21 into three-phase alternating-current (AC) power and drives motor generator MG1, for example, to start engine 30. Inverter 22 converts AC power generated by motor generator MG1 with motive power transmitted from engine 30 into DC power and sends resultant DC power back to boost converter 21. At this time, boost converter 21 is controlled to operate as a down-conversion circuit. Inverter 23 converts DC power outputted from boost converter 21 into three-phase AC power and outputs resultant AC power to motor generator MG2.

Power split device 40 is a mechanism coupled to engine 30 and motor generators MG1 and MG2 to distribute motive power thereamong. A planetary gear mechanism can be employed as power split device 40, and for example, engine 30 is connected to a planetary carrier, motor generator MG1 is connected to a sun gear, and motor generator MG2 is connected to a ring gear. A rotor of motor generator MG2 (and a rotation shaft of the ring gear of power split device 40) is coupled to drive wheel 50 with a reduction gear, a differential gear, and a driveshaft that are not shown being interposed.

Boost converter 21 of PCU 20 includes a reactor and switching elements Q1a, Q1b, Q2a, and Q2b. Switching elements Q1a to Q2b are each implemented, for example, by an insulated gate bipolar transistor (IGBT) element, and each of them includes a diode connected in anti-parallel to the IGBT element. Switching element Q1a and switching element Q1b are provided in parallel. Switching element Q2a and switching element Q2b are provided in parallel. Switching element Q1a and switching element Q1b are driven by an identical drive signal. Switching element Q2a and switching element Q2b are driven by an identical drive signal. Switching elements Q1a and Q1b have their collectors connected to a positive electrode line P1. Switching elements Q2a and Q2b have their emitters connected to a negative electrode line N1. The reactor is connected to emitters of switching elements Q1a and Q1b and collectors of switching elements Q2a and Q2b.

Inverter 22 is a three-phase inverter, and includes a U-phase arm composed of switching elements Q3 and Q4 connected in series between positive electrode line P1 and negative electrode line N1, a V-phase arm composed of switching elements Q5 and Q6 connected in series between positive electrode line P1 and negative electrode line N1, and a W-phase arm composed of switching elements Q7 and Q8 connected in series between positive electrode line P1 and negative electrode line N1. Switching elements Q3 to Q8 are switching elements each including a diode connected in anti-parallel to an IGBT element, similarly to switching element Q1a.

Intermediate points of the arms of respective phases are connected to coils of respective phases of motor generator MG1 with an MG1 connection terminal 26 being interposed. Motor generator MG1 is a three-phase permanent magnet synchronous motor, and it may be, for example, an interior permanent magnet (IPM) synchronous electric motor.

Inverter 23 is a three-phase inverter similar in configuration to inverter 22 except for switching elements in the arms of respective phases are provided in parallel. Switching elements Q9a and Q9b correspond to switching element Q3 and switching elements Q10a and Q10b correspond to switching element Q4, and the U-phase arm is constituted of them. Switching elements Q11a and Q11b correspond to switching element Q5 and switching elements Q12a and Q12b correspond to switching element Q6, and the V-phase arm is constituted of them. Switching elements Q13a and Q13b correspond to switching element Q7 and switching elements Q14a and Q14b correspond to switching element Q8, and the W-phase arm is constituted of them.

Intermediate points of the arms of respective phases are connected to coils of respective phases of motor generator MG2 with an MG2 connection terminal 27 being interposed. Motor generator MG2 may also be an IPM synchronous electric motor.

PCU 20 is provided with a current sensor iu that detects a U-phase current iu in each of inverter 22 and inverter 23, a current sensor iv that detects a V-phase current iv in each of inverter 22 and inverter 23, and a current sensor iw that detects a W-phase current iw in each of inverter 22 and inverter 23. PCU 20 includes a voltage sensor VH that detects a system voltage VH which is a voltage supplied from boost converter 21 to inverters 22 and 23 and a voltage sensor VL that detects a voltage VL inputted from battery pack 1 to boost converter 21.

Electrically powered vehicle V includes a hybrid electronic control unit (HV-ECU) 200, a motor generator ECU (MG-ECU) 210, a battery ECU (BT-ECU) 220, and an engine ECU (EG-ECU) 230 as control devices. Each ECU includes a central processing unit (CPU), a memory, and a buffer (none of which is shown).

Monitoring unit 15 includes a voltage sensor VB that detects voltage VB of battery 10, a current sensor IB that detects input and output current IB, or the like. BT-ECU 220 calculates a state of charge (SOC) of battery 10 based on voltage VB, input and output current IB, or the like detected by monitoring unit 15 and transmits the SOC to HV-ECU 200.

HV-ECU 200 calculates requested drive torque Tr, for example, based on an accelerator position, a vehicle speed, or the like for travel control of electrically powered vehicle V and calculates requested power Pd by multiplying requested drive torque Tr by a rotation speed of drive wheel 50. HV-ECU 200 sets requested power Pe requested of engine 30 by subtracting charging and discharging power Pb (a positive value in discharging from battery 10) based on the SOC of battery 10 from requested power Pd. HV-ECU 200 then sets a target engine rotation speed Ne, target engine torque Te, command torque Tm1 for motor generator MG1, and command torque Tm2 for motor generator MG2 such that requested power Pe is outputted from engine 30 and requested drive torque Tr is outputted to drive wheel 50.

MG-ECU 210 subjects each switching element of inverter 22 to pulse width modulation (PWM) control such that command torque Tm1 is outputted from motor generator MG1. MG-ECU 210 subjects each switching element of inverter 23 to pulse width modulation (PWM) control such that command torque Tm2 is outputted from motor generator MG2.

EG-ECU 230 controls engine 30 to operate at target engine rotation speed Ne and target engine torque Te.

Referring to FIG. 1, in power supply system P, battery pack 1 and PCU 20 mounted on electrically powered vehicle V are diverted for use as battery pack 1 and converter 2. Positive terminals of output terminals of three battery packs 1 (1-1-1, 1-1-2, and 1-1-3) are connected to MG2 connection terminal 27 to which the intermediate points of the arms of respective phases (the U-phase arm, the V-phase arm, and the W-phase arm) of inverter 23 (three-phase inverter) of PCU 20 are connected, with a coil (inductor) 5 being interposed. A power line between the positive terminal of battery pack 1 and coil 5 is connected to the negative terminal of the output terminal of battery pack 1 with a capacitor 6 being interposed. Battery pack 1 has the negative terminal connected to negative electrode line N1 of PCU 20 through a power line N11. FIG. 1 does not show monitoring unit 15.

In FIG. 1, switching element Q4, switching element Q5, and switching element Q7 of inverter 22 of PCU 20 are short-circuited. At MG1 connection terminal 26 to which the intermediate points of the arms of respective phases of inverter 22 are connected, a terminal to which the U-phase arm is connected is connected to the negative terminal of battery connection terminal 25 through a power line N12. Battery connection terminal 25 has the negative terminal connected to a negative terminal 28b of a power supply sub unit Su. At MG1 connection terminal 26, terminals to which the V-phase arm and the W-phase arm are connected are connected to a positive terminal 28a of power supply sub unit Su through a power line P11.

As the arms of respective phases of inverter 23 of PCU 20 are thus connected to battery pack 1, at least one of the switching elements of inverter 22 is short-circuited, and MG1 connection terminal 26 is connected to positive terminal 28a and negative terminal 28b of power supply sub unit Su, PCU 20 is diverted for use as converter 2 that boosts the voltage of battery pack 1 (battery 10) connected to the arms of the phases of inverter 23.

In FIG. 1, battery pack 1 corresponds to an exemplary “cell” in the present disclosure. A chopper circuit composed of the arms of the respective phases corresponding to one battery pack 1 (connected to one battery pack 1), coil 5, and capacitor 6 corresponds to the “converter” in the present disclosure. In FIG. 1, for the sake of convenience, the three converters collectively have a reference numeral 2 allotted. A feature including battery pack 1 and single converter 2 corresponds to the “cell unit” in the present disclosure. For example, in FIG. 1, battery pack 1-1-1, the U-phase arm (switching elements Q9b, Q9b, Q10a, and Q10b), coil 5 connected to the intermediate point of the U-phase arm, and capacitor 6 provided in the power line between the positive terminal of battery pack 1-1-1 and coil 5 correspond to the “cell unit” in the present disclosure. In the description of the present embodiment, a cell unit has a reference numeral Bu allotted without the cell units being distinguished from each other.

Power supply sub unit Su is composed of three cell units Bu each including converter 2 diverted from PCU 20. In power supply sub unit Su, power supply units Bu are connected in parallel. Power supply system P includes a plurality of power supply sub units Su, and power supply sub units Su are connected in parallel with respect to a PCS 100. In the present embodiment, power supply sub unit Su includes n (n being a positive integer) power supply sub units. Power supply sub unit Su may include, for example, twenty power supply sub units Su. In power supply sub unit Su, three cell units Bu (battery packs 1) are connected in parallel. In power supply system P including twenty power supply sub units Su, sixty cell units Bu (battery packs 1) are connected in parallel. In FIG. 1, n in a reference numeral Su-n indicates an nth power supply sub unit Su. n in the reference numerals 1-n-1, 1-n-2, and 1-n-3 indicates battery pack 1 included in nth power supply sub unit Su.

Positive terminal 28a of each power supply sub unit Su is connected to an input and output terminal of PCS 100 through a positive electrode line PL. Negative terminal 28b of each power supply sub unit Su is connected to the input and output terminal of PCS 100 through a negative electrode line NL.

PCS 100 is connected not only to power supply system P but also to a power grid PG, a photovoltaic power generator 650, and a load (electrical load) 300. Power grid PG is, for example, a commercial power supply composed of a power plant and a power transmission network. PCS 100 includes a power conversion device, and supplies electric power generated by photovoltaic power generator 650 to load 300 or performs back feeding. When there is a posiwatt DR request, PCS 100 converts AC power of power grid PG into DC power and charges power supply system P (cell unit Bu). When there is a negawatt DR request, PCS 100 converts discharging power (output power) from power supply system P (cell unit Bu) into AC power and performs back feeding. Load 300 may be a household load (home appliance) or an electrical load in a business entity or a factory.

Power supply system P performs an interconnected operation in which electric power is supplied and received to and from power grid PG and an isolated operation in which power supply system P is isolated (cut off) from power grid PG. In the interconnected operation, electric power from power grid PG is mainly supplied to load 300. In the interconnected operation, power supply system P supplies and receives electric power to and from power grid PG in response to a request for negawatt DR or posiwatt DR. During the isolated operation of power supply system P, output power (discharging power) from power supply system P (cell unit Bu) is supplied to load 300.

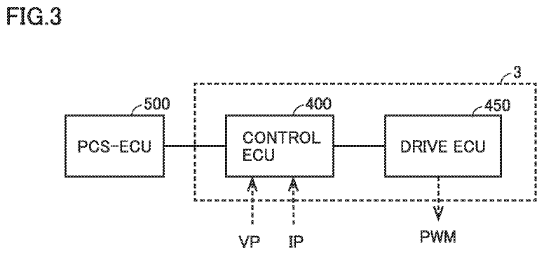

FIG. 3 is a diagram showing an exemplary configuration of control device 3 of power supply system P. Control device 3 includes a control ECU 400 and a drive ECU 450. Each ECU includes a CPU, a memory, and a buffer (none of which is shown). A PCS-ECU 500 is a control device that controls PCS 100 and outputs to control ECU 400, a power command RP which is a requested value of electric power to be outputted from power supply system P (cell unit Bu) or a requested value of electric power to be inputted to power supply system P and a voltage command RV which is a command value of a voltage to be outputted from power supply system P.

Control ECU 400 generates a power command TP based on power command RP and voltage command RV in output of electric power from power supply system P (in discharging from cell unit Bu). Drive ECU 450 subjects the cell unit (converter 2) to PWM control such that output power from power supply system P (cell unit Bu) attains to power command TP.

### First Embodiment

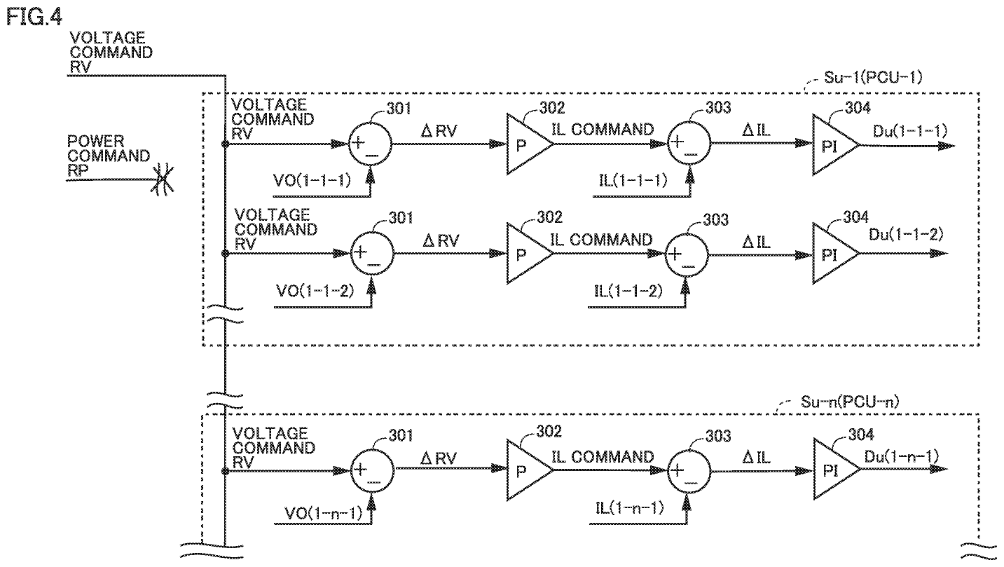

FIG. 4 is an exemplary block diagram for control of output power from power supply system P in a first embodiment. This block diagram may be configured by software and/or hardware in control ECU 400 and drive ECU 450. In FIG. 4, voltage command RV and power command RP are inputted from PCS-ECU 500. Voltage command RV may indicate a requested value (target voltage) of the output voltage from power supply system P, and it may be set, for example, to 100 V, 200 V, or 600 V. Power command RP may indicate electric power requested by a load or the like (to be supplied to the load or the like) connected to PCS 100.

For example, when voltage control is carried out in prescribed cell unit Bu such that an output voltage VP from power supply system P attains to voltage command RV and power control is carried out in another cell unit Bu such that output power OP from power supply system P attains to power command RP, a difference between output power OP and power command RP is produced (power deviation occurs) due to an error of the current sensor or response delay in power control and output voltage VP varies. Since voltage control is carried out in response to this variation in output voltage VP, an amount of operations by prescribed cell unit Bu subjected to voltage control increases, loads (burdens) imposed on that cell unit Bu increases, and deterioration of (battery pack 1 included in) that cell unit Bu may be accelerated. Therefore, in the first embodiment, in order to equalize the loads (burdens) imposed on cell units Bu (battery packs 1), voltage control is carried out in all cell units Bu.

In the first embodiment, voltage control is carried out in all cell units Bu without the use of power command RP inputted from PCS 100. The block diagram in FIG. 4 shows the block diagram for PWM control of the converter for each cell unit Bu. Since cell units Bu are common in block diagram, cell unit Bu including battery pack 1-1-1 will be described.

Voltage command RV inputted from PCS-ECU 500 and a unit output voltage VO (1-1-1) which is an output voltage from cell unit Bu are inputted to a subtraction point 301. A difference ΔRV between voltage command RV and unit output voltage VO (1-1-1) is outputted from subtraction point 301 to a P controller 302. Unit output voltage VO (1-1-1) may be a detection value detected by voltage sensor VH that detects system voltage VH, voltage sensor VH having been provided in PCU 20 diverted for use in a power supply sub unit Su-1. In this case, voltage sensor VH corresponds to an exemplary “voltage sensor that detects a unit voltage” in the present disclosure.

P controller 302 serves for feedback control only under proportional control, and it outputs an IL command, for example, by multiplying difference ΔRV by a constant of proportionality (proportional gain) Kp. The IL command is a current command indicating a current to be outputted from cell unit Bu.

The IL command outputted from P controller 302 and IL (1-1-1) which represents an output current from cell unit Bu are inputted to a subtraction point 303. A difference ΔIL between the IL command and IL (1-1-1) is outputted from subtraction point 303 to a PI controller 304. IL (1-1-1) represents an output current from cell unit Bu including battery pack 1-1-1 and it may represent a detection value detected by current sensor iu that detects U-phase current iu of the U phase to which battery pack 1-1-1 is connected or a detection value detected by current sensor IB that detects input and output current IB to and from battery 10 in battery pack 1-1-1.

PI controller 304 serves for feedback control under proportional integral control (PI control) and outputs a duty ratio Du (1-1-1) resulting from addition of a proportional term and an integral term such that difference ΔIL is 0 (IL (1-1-1) is equal to the IL command). Converter 2 (the U-phase arm (switching elements Q9a, Q9b, Q10a, and Q10b)) of cell unit Bu including battery pack 1-1-1 is subjected to PWM control at duty ratio Du (1-1-1). All cell units Bu are similarly controlled.

According to this first embodiment, voltage control for control of each of converters 2 of cell units Bu is carried out, with voltage command RV being defined as the input parameter, voltage command RV being a command value for output voltage VP from power supply system P. Since voltage control is thus carried out in each cell unit Bu even when there is a difference between output power OP and power command RP (even when power deviation occurs), loads (burdens) imposed on cell units Bu can be equalized. When output power OP from power supply system P becomes lower than power command RP, output voltage VP is lowered and hence voltage control is carried out to increase output power OP. When output power OP becomes higher than power command RP, output voltage VP increases and hence voltage control to lower output power OP is carried out. Output power OP is thus also controlled to satisfy power command RP.

According to this first embodiment, voltage control carried out by control device 3 is feedback control only under proportional control by P controller 302 such that unit output voltage VO (N) attains to voltage command RV. Since feedback control is carried out only under proportional control such that unit output voltage VO (N) attains to voltage command RV, control interference between cell units Bu can be suppressed. “N” in unit output voltage VO (N) corresponds to the reference numeral of the battery pack included in that cell unit Bu and a unit output voltage from cell unit Bu including a battery pack 1-n-1 is denoted as a unit output voltage VO (1-n-1). “N” is handled similarly hereafter, and “N” is assumed to correspond to the reference numeral of the battery pack.

When feedback control is carried out only under proportional control such that unit output voltage VO (N) attains to voltage command RV, no integral term (integral control) is included and hence unit output voltage VO (N) is less likely to converge to voltage command RV. When gain Kp in proportional control is increased such that unit output voltage VO (N) is brought closer to voltage command RV, unit output voltage VO (N) greatly varies. In some embodiments, gain Kp for proportional control is found in advance in experiments or the like such that variation in unit output voltage VO (N) is within a range allowable in PCS 100, and voltage control is carried out with the use of this gain Kp so that variation in unit output voltage VO (N) is within the range allowable by PCS 100 while unit output voltage VO (N) is brought closer to voltage command RV.

### Second Embodiment

In a second embodiment, voltage control is carried out in all cell units Bu in order to equalize loads (burdens) imposed on cell units Bu (battery packs 1). A drooping characteristic (droop) is applied to the voltage command for each cell unit Bu to suppress control interference between cell units Bu.

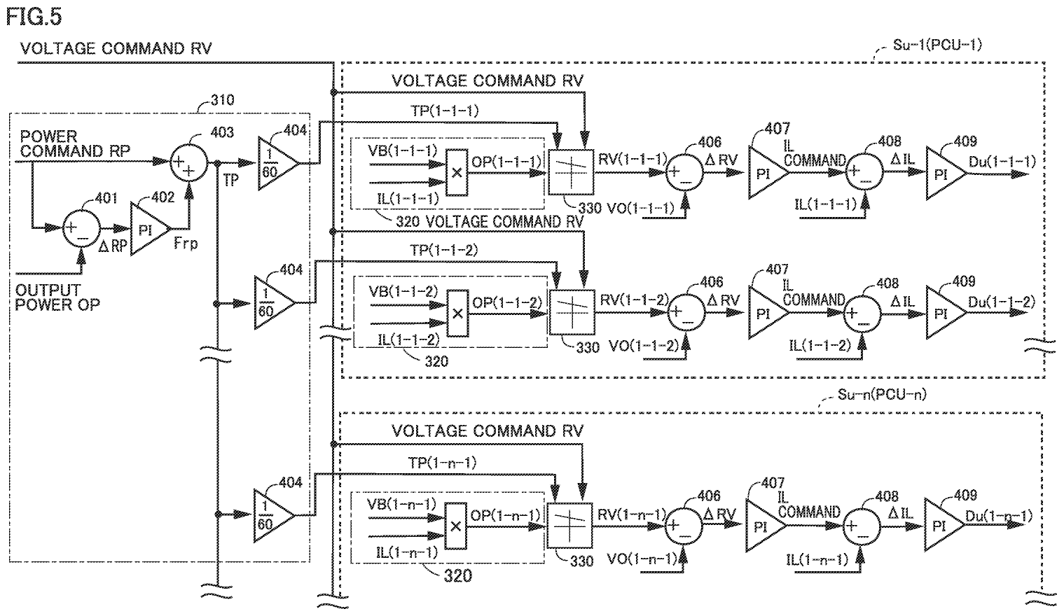

FIG. 5 is an exemplary block diagram for control of output power from power supply system P in the second embodiment. This block diagram may be configured by software and/or hardware in control ECU 400 and drive ECU 450. In FIG. 5, voltage command RV and power command RP are inputted from PCS-ECU 500 as in the first embodiment.

In FIG. 5, a power command calculator 310 calculates a unit power command TP (N) which is a command value for output power from each cell unit Bu. As described above, “N” corresponds to the reference numeral of the battery pack included in that cell unit Bu. Power command RP inputted from PCS-ECU 500 and output power OP are inputted to a subtraction point 401. Output power OP is output power from power supply system P and may be calculated from output voltage VP and an output current IP from the power supply system. A difference ΔRP between power command RP and output power OP is outputted from subtraction point 401 and inputted to a PI controller 402. PI controller 402 serves for feedback control by proportional integral control (PI control) and outputs a power correction Frp such that difference ΔRP is 0 (output power OP is equal to power command RP).

Power command RP and power correction Frp are inputted to an addition point 403 of power command calculator 310. Addition point 403 outputs an output power command TP for power supply system P. Output power command TP outputted from addition point 403 is inputted to a distributor 404. Distributor 404 outputs a unit power command TP (N) which is a command value for output power (unit output power) from each cell unit Bu. In power supply system P in the present embodiment, sixty cell units Bu are connected in parallel. Distributor 404 distributes 1/60 of output power command TP to each cell unit Bu. For example, distributor 404 multiplies output power command TP by “ 1/60” and outputs unit power command TP (N).

Since the block diagram downstream from power command calculator 310 is common among cell units Bu, cell unit Bu including battery pack 1-1-1 will be described below.

An output power obtaining unit 320 obtains unit output power OP (1-1-1) from cell unit Bu. In the present embodiment, unit output power OP (1-1-1) is obtained by multiplication of voltage VB (1-1-1) of battery 10 included in battery pack 1-1-1 by IL (1-1-1) representing the output current from cell unit Bu (battery pack 1-1-1). Unit output power OP (1-1-1) obtained (calculated) by output power obtaining unit 320 is inputted to a voltage command correction unit 330.

Voltage command correction unit 330 calculates corrected voltage command RV (1-1-1) by correcting voltage command RV. Voltage command RV outputted from PCS-ECU 500, a unit power command TP (1-1-1) outputted from power command calculator 310 (distributor 404), and unit output power OP (1-1-1) outputted from output power obtaining unit 320 are inputted to voltage command correction unit 330.

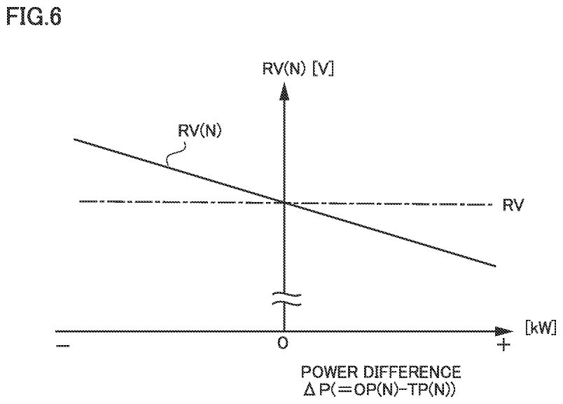

FIG. 6 is a diagram illustrating corrected voltage command RV (N) calculated by voltage command correction unit 330. In FIG. 6, the ordinate represents corrected voltage command RV (N) and the abscissa represents a power difference ΔP. Power difference ΔP is calculated by subtracting unit power command TP (N) from unit output power OP (N) (ΔP=OP (N)−TP (N)). As shown in FIG. 6, when power difference ΔP is 0 (unit output power OP (N) is equal to unit power command TP (N)), corrected voltage command RV (N) is set to voltage command RV. Relation between power difference ΔP and corrected voltage command RV (N) is linear.

Referring to FIG. 6, corrected voltage command RV (N) has a value corrected to decrease voltage command RV as power difference ΔP is larger while unit output power OP (N) is higher than unit power command TP (N) and power difference ΔP has a positive value. Alternatively, corrected voltage command RV (N) has a value corrected to increase voltage command RV as power difference ΔP is larger while unit output power OP (N) is lower than unit power command TP (N) and power difference ΔP has a negative value.

Voltage command correction unit 330 calculates corrected voltage command RV (N) by correcting voltage command RV in accordance with power difference ΔP (=OP (N)−TP (N)) based on the relation (characteristic) shown in FIG. 6 and outputs the corrected voltage command to a subtraction point 406. (In cell unit Bu including battery pack 1-1-1, corrected voltage command RV (1-1-1) is outputted to subtraction point 406.) Corrected voltage command RV (1-1-1) outputted from voltage command correction unit 330 and unit output voltage VO (1-1-1) which is an output voltage from cell unit Bu are inputted to subtraction point 406. A difference ΔRV between corrected voltage command RV (1-1-1) and unit output voltage VO (1-1-1) is outputted from subtraction point 406 to a PI controller 407. Unit output voltage VO (1-1-1) may be a detection value detected by voltage sensor VH that detects system voltage VH, voltage sensor VH having been provided in PCU 20 diverted for use in power supply sub unit Su-1. This voltage sensor VH corresponds to an exemplary “voltage sensor that detects a unit voltage” in the present disclosure.

PI controller 407 serves for feedback control under proportional integral control (PI control) and outputs an IL command such that difference ΔRV is 0 (unit output voltage VO (1-1-1) is equal to corrected voltage command RV (1-1-1)). The IL command is a current command indicating a current to be outputted from cell unit Bu.

The IL command outputted from PI controller 407 and IL (1-1-1) which represents an output current from cell unit Bu are inputted to a subtraction point 408. Difference ΔIL between the IL command and IL (1-1-1) is outputted from subtraction point 408 to a PI controller 409. IL (1-1-1) represents an output current from cell unit Bu including battery pack 1-1-1 and it may represent a detection value detected by current sensor iu that detects U-phase current iu of the U phase to which battery pack 1-1-1 is connected or a detection value detected by current sensor IB that detects input and output current IB to and from battery 10 in battery pack 1-1-1.

PI controller 409 serves for feedback control under proportional integral control (PI control) and outputs duty ratio Du (1-1-1) resulting from addition of a proportional term and an integral term such that difference ΔIL is 0 (IL (1-1-1) is equal to the IL command). Converter 2 (the U-phase arm (switching elements Q9a, Q9b, Q10a, and Q10b)) of cell unit Bu including battery pack 1-1-1 is subjected to PWM control at duty ratio Du (1-1-1). All cell units Bu are similarly controlled.

According to this second embodiment, voltage control in which each of converters 2 of cell units Bu is controlled is carried out with voltage command RV being defined as the input parameter, voltage command RV being a command value for output voltage VP from power supply system P. Thus, even when there is a difference between output power OP and power command RP (power deviation occurs), voltage control is carried out in each cell unit Bu and hence loads (burdens) imposed on cell units Bu can be equalized.

According to this second embodiment, power command calculator 310 calculates unit power command TP (N) which is a command value for output power from each of cell units Bu based on power command RP which is a command value for output power from power supply system P. Voltage command correction unit 330 calculates corrected voltage command RV (N) by correcting voltage command RV to be smaller as the difference (power difference ΔP) between unit power command TP (N) and unit output power OP (N) is larger while unit output power OP (N) is higher than unit power command TP (N) (power difference ΔP is positive) and correcting voltage command RV to be larger as the difference (power difference ΔP) between unit power command TP (N) and unit output power OP (N) is larger while unit output power OP (N) is lower than unit power command TP (N) (power difference ΔP is negative). Voltage control carried out by control device 3 is feedback control such that unit output voltage VO (N) attains to corrected voltage command RV (N). Unit output voltage VO (N) of cell unit Bu is controlled to be lower while unit output power OP (N) is higher than unit power command TP (N), and unit output voltage VO (N) of cell unit Bu is controlled to be higher while unit output power OP (N) is lower than unit power command TP (N). Therefore, control interference between cell units Bu can be suppressed.

When unit output power OP (N) is equal to unit power command TP (N) (power difference ΔP is 0), voltage command RV is set to corrected voltage command RV (N) without voltage command RV being corrected, and hence output voltage VP from power supply system P can be controlled to attain to voltage command RV. Furthermore, since relation between power difference ΔP and corrected voltage command RV (N) is set to be linear, unit output voltage VO (N) can be controlled in a stable manner.

In the embodiment, power supply system P is constituted of a plurality of power supply sub units Su connected in parallel. Input and output power of power supply system P can thus be higher.

According to the embodiment, inverter 23 (three-phase inverter) included in PCU 20 of electrically powered vehicle V is diverted for use as converter 2 of power supply sub unit Su. Battery pack 1 of electrically powered vehicle V is used as battery pack 1 of power supply sub unit Su. Therefore, reuse of a battery or a PCU collected on the occasion of replacement purchase or disassembly of electrically powered vehicle V can be promoted.

(First Modification)

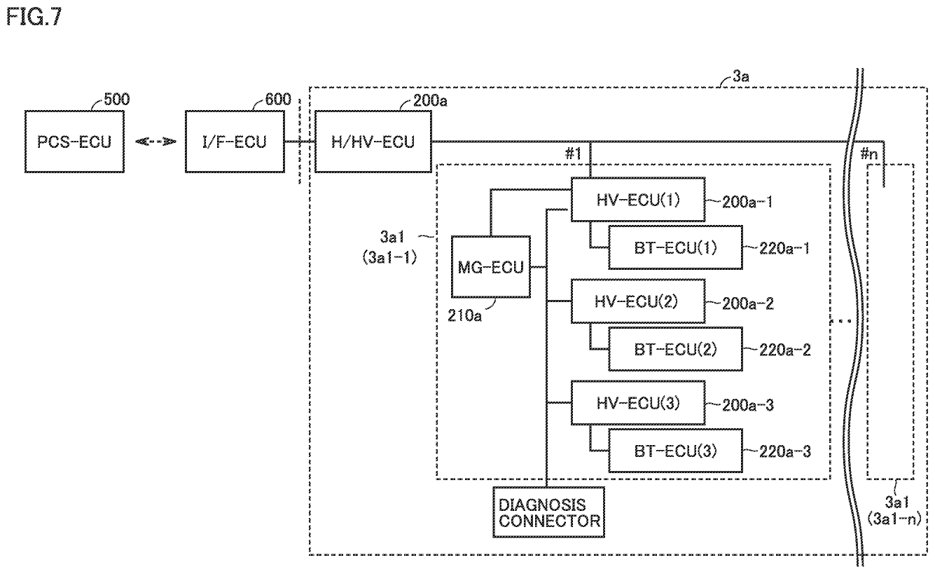

FIG. 7 is a diagram illustrating a control device 3a of power supply system P according to a first modification. Control device 3a in the first modification utilizes and makes use of HV-ECU 200, MG-ECU 210, and BT-ECU 220 mounted on electrically powered vehicle V. In FIG. 7, HV-ECU 200 mounted on electrically powered vehicle V is utilized and made use of as an H/HV-ECU 200a and an HV-ECU (1) 220a-1 to an HV-ECU (3) 220a-3. MG-ECU 210 is utilized and made use of as an MG-ECU 210a. BT-ECU 220 is utilized and made use of as a BT-ECU (1) 220a-1 to a BT-ECU (3) 220a-3.

In FIG. 7, an interface ECU (I/F-ECU) 600 connects PCS-ECU 500 and control device 3a (H/HV-ECU 200a) to each other and adjusts consistency between a communication protocol of PCS-ECU 500 and a communication protocol of control device 3a. H/HV-ECU 200a computes power command TP (N) or the like for each cell unit Bu based on power command RP, voltage command RV, or the like received from PCS-ECU 500.

A sub control device 3a1 composed of MG-ECU 210a, HV-ECU (1) 200a-1 to HV-ECU (3) 200a-3, and BT-ECU (1) 220a-1 to BT-ECU (3) 220a-3 is a control device that controls power supply sub unit Su. In FIG. 7, a sub control device 3a1-1 is a control device that controls power supply sub unit Su-1 in FIG. 1 and sub control device 3a1 is provided for each power supply sub unit Su. Specifically, control device 3a includes n sub control devices 3a1 from sub control device 3a1-1 to a sub control device 3a1-n.

In FIG. 7, BT-ECU (1) 220a-1 monitors voltage VB, input and output current IB, a temperature, and the like of battery 10 of battery pack 1-1-1 of power supply sub unit Su-1 and calculates the SOC. HV-ECU (1) 200a-1 controls switching of SMR 11 of battery pack 1-1-1 based on power command TP (1-1-1) or voltage command RV. HV-ECU (1) 200a-1 detects a degree of deterioration of battery 10 of battery pack 1-1-1. A BT-ECU (2) 220a-2 and an HV-ECU (2) 200a-2 perform processing on a battery pack 1-1-2 similarly to BT-ECU (1) 220a-1 and HV-ECU (1) 200a-1. A BT-ECU (3) 220a-3 and an HV-ECU (3) 200a-3 perform processing on a battery pack 1-1-3 similarly to BT-ECU (1) 220a-1 and HV-ECU (1) 200a-1. MG-ECU 210a calculates duty ratio Du (1-1-1) as described above based on voltage command RV, power command TP (1-1-1), and the like, and controls converter 2 (drives the switching element in the U-phase arm of inverter 23).

A sub control device 3a1-2 to sub control device 3al-n also perform processing on a power supply sub unit Su-2 to power supply sub unit Su-n similarly to sub control device 3a1-1. According to this first modification, utilization and use of hardware of HV-ECU 200, MG-ECU 210, and BT-ECU 220 mounted on electrically powered vehicle V as the control device of power supply system P can be promoted. Such resources for controller area network (CAN) communication utilized in HV-ECU 200, MG-ECU 210, and BT-ECU 220 mounted on electrically powered vehicle V can also be made use of, and highly reliable multiplexed communication or monitoring can relatively easily be achieved.

(Second Modification)

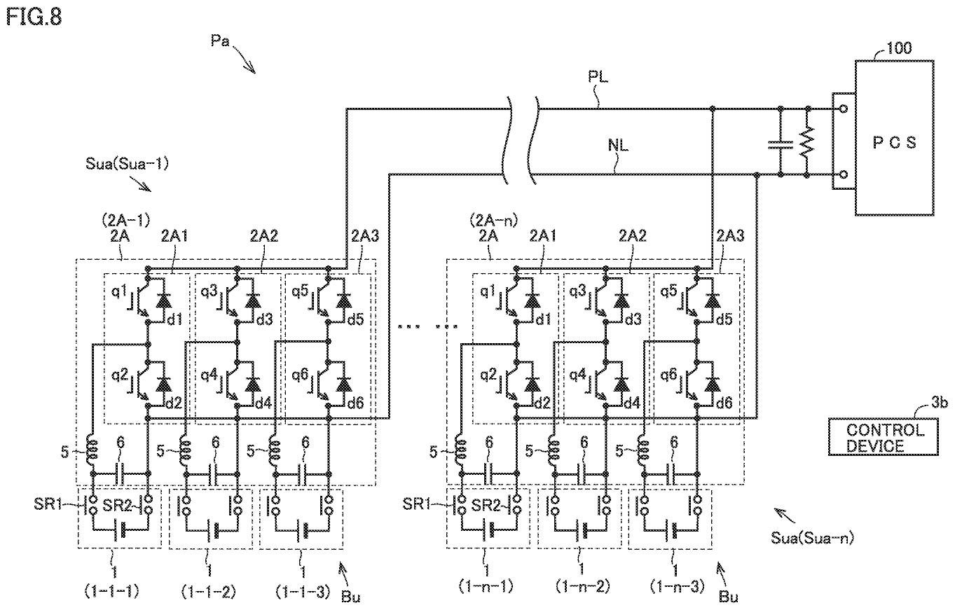

FIG. 8 is a diagram showing an overall configuration of a power supply system Pa in a second modification. In the embodiments, an example in which PCU 20 including boost converter 21, inverter 22, and inverter 23 is diverted for use as converter 2 of power supply system P is described. In the embodiments, in particular for conduction of high power, inverter 23 where switching elements are provided in parallel is utilized as the switching element of converter 2. Among PCUs mounted on electrically powered vehicles, however, there is a PCU where a single inverter is provided or a PCU without a boost converter.

In power supply system Pa in the second modification, a PCU including only a single inverter or a circuit resulting from extraction of an inverter portion from the PCU is diverted for use as a converter 2A thereof.

In FIG. 8, the inverter (three-phase inverter) of the PCU mounted on the electrically powered vehicle is diverted for use as converter 2A. In FIG. 8, SR1 and SR2 in battery pack 1 each represent a system main relay (SMR). As in the embodiments, the positive terminals of the output terminals of three battery packs 1 (1-1-1, 1-1-2, and 1-1-3) are connected to the intermediate points of the arms of phases (a U-phase arm 2A1, a V-phase arm 2A2, and a W-phase arm 2A3) of the three-phase inverter of the PCU with coils (inductors) 5 being interposed. The power line between the positive terminal of battery pack 1 and coil 5 is connected to the negative terminal of the output terminal of battery pack 1 with capacitor 6 being interposed. Upper arms of the arms (U-phase arm 2A1, V-phase arm 2A2, and W-phase arm 2A3) of the phases of the three-phase inverter are connected to positive electrode line PL and connected to the input and output terminal of PCS 100. Lower arms of the arms (U-phase arm 2A1, V-phase arm 2A2, and W-phase arm 2A3) of the phases of the three-phase inverter are connected to negative electrode line NL and connected to the input and output terminal of PCS 100. The negative terminal of battery pack 1 is connected to negative electrode line NL.

Thus, in power supply system Pa in the second modification, the arms of the phases of the three-phase inverter of the PCU are connected to battery pack 1 and the three-phase inverter is diverted for use as converter 2A, to thereby implement a power supply sub unit Sua including three cell units Bu. Power supply system Pa includes a plurality of power supply sub units Sua as in the embodiments and power supply sub units Sua are connected in parallel. A function and effect as in the embodiments is achieved also in this second modification by voltage control by a control device 3b as in the embodiments.

Though embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power supply system comprising:
a plurality of cell units each including a cell and a converter, the plurality of cell units being connected in parallel to each other; and
a control device that controls the converter, wherein
the control device carries out voltage control to control the converter in each of the plurality of cell units with a voltage command being defined as an input parameter, the voltage command being a command value for an output voltage from the power supply system.

2. The power supply system according to claim 1, further comprising a voltage sensor that detects a unit output voltage which is an output voltage from each of the plurality of cell units, wherein
the voltage control carried out by the control device is feedback control only under proportional control such that the unit output voltage attains to the voltage command.

3. The power supply system according to claim 2, wherein
a gain in the proportional control is set such that variation in the unit output voltage is within a prescribed range.

4. The power supply system according to claim 1, further comprising:
a voltage sensor that detects a unit output voltage which is an output voltage from each of the plurality of cell units; and
an output power obtaining unit that obtains unit output power which is output power from each of the plurality of cell units, wherein
the control device includes
a power command calculator that calculates a unit power command which is a command value for the unit output power based on a power command which is a command value for output power from the power supply system, and
a voltage command correction unit that calculates a corrected voltage command by (i) correcting the voltage command to be smaller as a difference between the unit power command and the unit output power is larger while the unit output power is larger than the unit power command and (ii) correcting the voltage command to be larger as the difference between the unit power command and the unit output power is larger while the unit output power is smaller than the unit power command, and
the voltage control carried out by the control device is feedback control such that the unit output voltage attains to the corrected voltage command.

5. The power supply system according to claim 4, wherein
the voltage command correction unit sets the voltage command to the corrected voltage command when the unit output power is equal to the unit power command.

6. The power supply system according to claim 5, wherein
the voltage command correction unit calculates the corrected voltage command such that relation between the difference and the corrected voltage command is linear.

7. The power supply system according to claim 1, wherein
a three-phase inverter is diverted for use as the converter, and
cells different from one another are connected to arms of respective phases of the three-phase inverter.
